(19) United States
(12) Patent Application Publication
(10) Pub. No.: US 2024/0122172 A1
(43) Pub. Date: Apr. 18, 2024

(54) Rodent Trap

(71) Applicant: Paul F. Gigante, Albany, NY (US)

(72) Inventor: Paul F. Gigante, Albany, NY (US)

(21) Appl. No.: 18/380,941

(22) Filed: Oct. 17, 2023

Related U.S. Application Data
(60) Provisional application No. 63/416,994, filed on Oct. 18, 2022.

(51) Int. Cl. A01M 23/30; A01M 23/00

(52) U.S. Cl. CPC A01M 23/30; A01M 23/005

(57) ABSTRACT

A trap for rodents includes a platform; a spring mounted on the platform; a hammer connected to the spring; a bar placed to hold the hammer in cocked position; a trigger; and an adhesive placed on a surface of the trigger. When subject to force, the trigger releases the bar, causing the hammer to swing down rapidly. The adhesive may be placed on the top surface of the trigger. The adhesive may also be placed on a surface of at least one opening in the trigger. The adhesive may be covered by a backing.

### CROSS-REFERENCE TO RELATED APPLICATIONS

The present application claims priority to U.S. Provisional Pat. Application No. 63/416,994 filed on Oct. 18, 2022, which is hereby incorporated by reference in its entirety.

### RELATED APPLICATIONS

At least one specification heading is required. Please delete this heading section if it is not applicable to your application. For more information regarding the headings of the specification, please see MPEP 608.01(a).

### FIELD OF THE INVENTION

The present application claims priority to U.S. Provisional Pat. Application No. 63/416,994 filed on Oct. 18, 2022, which is hereby incorporated by reference in its entirety.

### DESCRIPTION OF THE PRIOR ART

The use of trap structures is known in the prior art. One type of prior art mouse or rodent trap (FIG. 2) has a spring-actuated striker or hammer that is raised by depressing the outer end of a lever or arm rigid with a rotatable shaft supporting other elements and which is adapted to be secured or held in depressed position by a treadle or trigger passing underneath the shaft when adjusting or setting said trap. The lever or arm is released by tripping the treadle or trigger, springing the trap. This configuration allows the trap to be readily set or adjusted with absolute safety to the person attending to the trap, avoiding the possibility of having the person's fingers caught or injured by the striker or hammer when it is prematurely or accidentally freed or released.

The mouse or rodent is typically attracted to the trap by bait placed on the trigger, such as peanut butter or a hazelnut spread. The disadvantage of these type of traps and other traps in the prior art is that the animal is able to eat or otherwise remove the bait without triggering the trap. Some solutions that have been tried to remedy this problem include adjusting the settings of the trap to make the trap more sensitive to touch or increasing the size of the trigger plate (see FIGS. 1 and 3). Even after implementing these solutions, however, the mouse or rodent often removes the bait without triggering the trap.

Other types of traps, such as glue traps, used with or without bait, trap the animal when it steps on the trap and becomes stuck to the trap. Animals often avoid these traps, which also have the disadvantage of the animal often being alive when found by the user.

### SUMMARY OF THE INVENTION

In view of the foregoing disadvantages inherent in the known types of trap structures now present in the prior art, the present invention includes the provision of an adhesive or glue to the trigger. While the provision of an adhesive or glue may be used with the prior art traps described above, the application of adhesive or glue may be used on any type of trap with a paddle or trigger device. The glue or adhesive may be placed on the trigger or paddle, or on the platform. When the mouse or other rodent begins to eat or try to remove the bait, it will get stuck to the glue or adhesive and try to pull away. When the animal makes this movement, it will contact or otherwise place a force on the trigger, springing the trap. The animal will then be trapped.

The disclosed invention is not anticipated, rendered obvious, or suggested by any of the prior art trap structures, either alone or in any combination.

The disclosed invention insures a more effective percentage catch rate to the user, reducing the expense and time involved in using traps. The new mouse or rodent trap may be easily and efficiently manufactured and marketed. It will also have a durable and reliable construction. The disclosed mouse trap will have a low cost of manufacture with regard to both materials and labor, and the inclusion of adhesive is a low-cost means of adding value for the customer.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS/IMAGES

FIG. 1 is an image of a mouse trap with a plastic trigger plate that may comprise part of the invention.

FIG. 2 is an plan of a trap that may be used as part of this invention. The trap has been sprung in this illustration.

FIG. 3 is an image of a mouse trap with a different plastic trigger plate that may comprise part of the invention.

FIG. 4 is a drawing of a preferred embodiment showing a glue or other adhesive with a paper backing on the trigger of the trap.

### DESCRIPTION OF THE PREFERRED EMBODIMENT

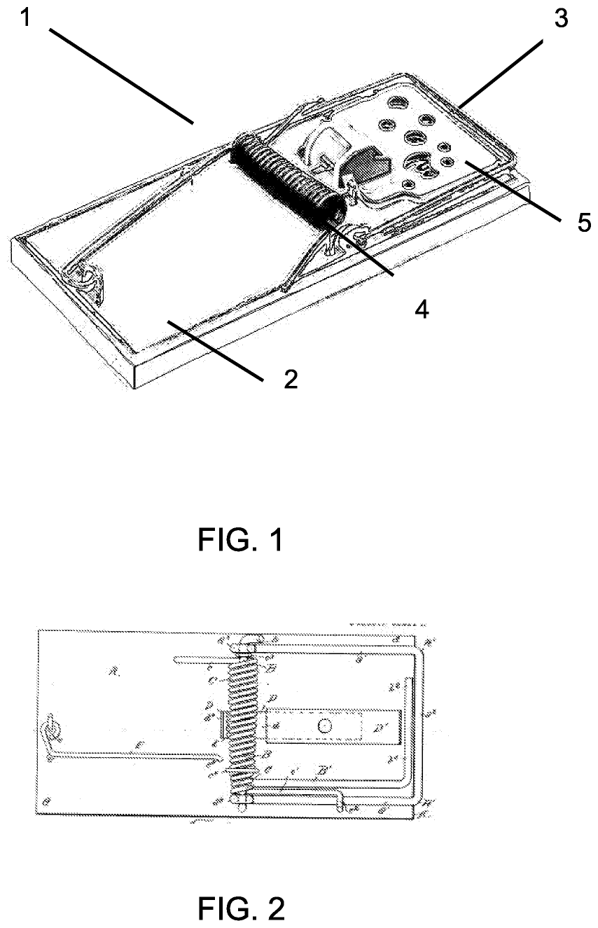

With reference now to the drawings and images, and in particular to FIGS. 1-3 thereof, a new mouse trap embodying the principles and concepts of the present invention will be described.

FIG. 2 shows the basic structure of the prior art mouse trap A, previously set forth in U.S. Pat. No. 744,379. A trap A comprises a practically rectangular body or base a on which is arranged a practically U-shaped striker A′, having two parallel side bars a′ a′ with the forward ends joined by a cross-bar a2 hanging over the forward edge of the base, and being in close contact with the base when the trap is sprung. The side bars a′ a′ have their rearward or free ends bent over, so as to form eyes a3 for pivoting the striker in place. Through the eyes a3 is passed a rod or shaft B that has: (1) one end turned over into an L-shaped hook b to prevent the end from slipping through the adjacent eye; and (2) a second end turned over a prescribed distance, forming an introverted fold b′, embracing the adjacent striker-bar a′ where the end is turned over at an angle of ninety degrees with the shaft B and a vertically-disposed acute angle with the curved end of the fold b′, constituting the lever-arm B′, of the required length, where it is continued at an angle of ninety degrees into the branch b2, whereby the lever-arm is raised and depressed to lift the striker and set the trap.

Surrounding the shaft B is coiled a spring C, which has one end extending into an arm c, which passes underneath the shaft with its extremity resting on top of the base a, and the other end extending into an arm c′, which passes underneath the shaft between it and the introverted arm of the fold b′, with its extremity bent upwardly and outwardly, forming a curve c2, engaging on top of the adjacent striker-bar a′, the shaft being pivoted in place by a staple c3, which embraces the shaft and is driven into the base a, and the other end by a staple c4, which embraces the coiled spring C and is also driven into the base, and a staple c5, which is placed underneath the spring at this point and is likewise driven into the base, serving to keep the spring and shaft upwardly in place, while the resiliency of the arm c serves to perform the same functions at the other end, determining a space underneath the spring and shaft for the pivoting and working of the setting and springing trigger.

On the longitudinal center line of the base and the space between the line and the spring is arranged the trigger D, comprising a strip d having its rearward end d′ abruptly turned up, forming an acute angle, with its upper end turned out rearwardly, forming a lip or latch hook d2, which is adapted to hold the forward end of the lever-holding arm in setting or adjusting the striker and having secured, preferably on top, to its forward end a body or block D′, constituting a platform or treadle whereby the trigger may be depressed. The trigger is preferably pivoted in place to the base of the trap by means of a staple D2, having its prongs or arms passing through orifices in the strip immediately forward of its upturned end and driven into said base, and the trigger is so arranged that its platform or treadle will lie on the base a when the trap is sprung.

In the rearward portion of the trap on the longitudinal center line of its base a is arranged the striker-lever-holding arm E, of the required dimensions, being bent and shaped as shown, having at its rearward end an eye e through which a staple driven into the base serves to pivot said arm thereto, and the arm having a crook e′ that passes above the branch of the lever-arm B′, with its forward end turned up into a crook e2 to engage under the lip-hook d2 of the trigger D, which serves to hold said lever-arm in depressed position, adjusting the striker and setting the trap.

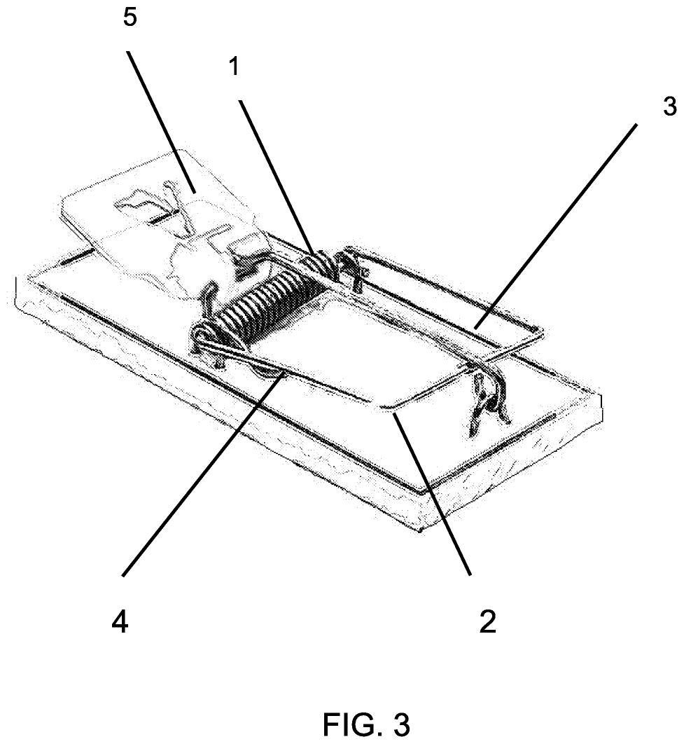

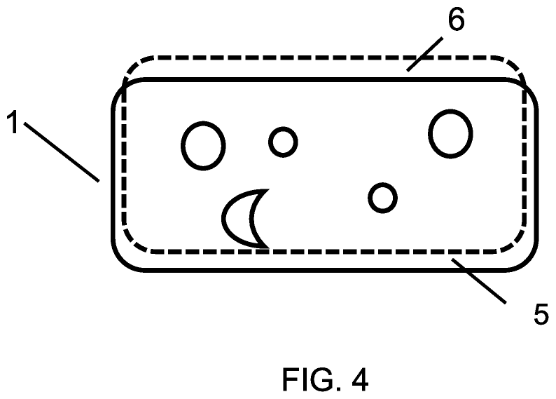

The images in FIG. 1 and FIG. 3 show traps 1 similar in configuration to that of FIG. 2, with a platform 2, hammer or striker 3, spring 4, and trigger plate 5. In FIGS. 1 and 3, the trigger plate 5 is made of plastic or similar material and is enlarged compared to the trigger D in FIG. 2. The trigger plates 5 of FIGS. 1 and 3 have openings. It may be appreciated that the invention may involve any type of trap with a paddle or trigger device, and is not limited to any particular embodiment, including those embodiments in FIGS. 1-3.

In the present invention, an adhesive or glue is placed on the trigger 5, preferably on the top surface of the trigger and/or the side surfaces of the openings. The adhesive may also optionally be placed on the top surface of the platform 2. The adhesive or glue may be of any type sufficient to cause the mouse or other rodent to get sufficiently stuck, even temporarily, so that it tries to pull away, thereby activating the trigger. One preferred embodiment is a glue or adhesive 6 with a pull-away backing placed on the top surface of the trigger plate 5, so that the glue or adhesive is protected during packaging and the user may place the trap without contacting the glue or adhesive. One the trap is in place, the backing can be pulled back from the trigger plate. The backing for the glue or adhesive can be of any type that allows the backing to be pulled away while leaving sufficient glue or adhesive on the trigger plate to achieve the purposes of the invention.

Certain features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A rodent trap comprising:
a platform;
a spring mounted on the platform;
a hammer connected to the spring;
a bar placed to hold the hammer in cocked position; and
a trigger that, when subject to a force, releases the bar, wherein, after the bar is released, the hammer swings down rapidly;
wherein an adhesive is placed on a surface of the trigger.

2. The trap of claim 1, wherein the adhesive is placed on the top surface of the trigger.

3. The trap of claim 1, wherein the trigger has openings and the adhesive is placed on the top surface of the trigger and on a surface of at least one opening.

4. The trap of claim 1, wherein the trigger has openings and the adhesive is placed on a surface of at least one opening.

5. The trap of claim 1, wherein the adhesive is covered by a backing.

6. A rodent trap comprising a trigger or paddle device, wherein an adhesive is placed on a surface of the trigger.

7. The trap of claim 6, wherein the adhesive is placed on the top surface of the trigger.

8. The trap of claim 6, wherein the trigger has openings and the adhesive is placed on the top surface of the trigger and on a surface of at least one opening.

9. The trap of claim 6, wherein the trigger has openings and the adhesive is placed on a surface of at least one opening.

10. The trap of claim 6, wherein the adhesive is covered by a backing.
